(19) United States
(12) Patent Application Publication
(10) Pub. No.: US 2019/0108520 A1
(43) Pub. Date: Apr. 11, 2019

(54) DISTRIBUTION SYSTEMS AND RELATED METHODS

(71) Applicant: MASTERCARD INTERNATIONAL INCORPORATED, PURCHASE, NY (US)

(72) Inventors: Joseph Zeltzer, Ridgewood, NJ (US); Anthony Hayes, Newtown, CT (US); Prashant Sharma, Madison, NJ (US); Saurabh Mehta, Elmsford, NY (US)

(21) Appl. No.: 16/148,110

(22) Filed: Oct. 1, 2018

Related U.S. Application Data
(60) Provisional application No. 62/569,066, filed on Oct. 6, 2017.

(51) Int. Cl. G06Q 20/40; G06Q 10/08; G06K 7/14

(52) U.S. Cl. CPC G06Q 20/401; G06K 7/1413; G06Q 10/083

(57) ABSTRACT

Systems and methods are provided for facilitating payment, at a courier terminal of a courier, on delivery of products offered by multiple different merchants. One exemplary method includes receiving, by a computing device, an order record from a merchant identifying a product ordered by a consumer and including a merchant ID for the merchant. The computing device then retrieves, from a data structure, a payment gateway address associated with the merchant ID and modifies the order record to include the payment gateway address. The payment gateway address is for a payment gateway associated with the merchant. The computing device then transmits the modified order record to the courier, thereby permitting the payment gateway address to be imposed on the courier terminal such that a payment account transaction initiated at the courier terminal for payment on delivery of the product is directed to an account specific to the merchant.

### CROSS-REFERENCE TO RELATED APPLICATION

This application claims the benefit of, and priority to, U.S. Provisional Application No. 62/569,066 filed on Oct. 6, 2017. The entire disclosure of the above application is incorporated herein by reference.

### FIELD

The present disclosure generally relates to distribution systems and related methods, and in particular, to distribution systems for facilitating, providing, etc. delivery of products to consumers (from merchants), whereupon payment for the products is provided through courier terminals, in connection with delivery of the products, to payment gateways associated with the merchants.

### BACKGROUND

This section provides background information related to the present disclosure which is not necessarily prior art.

Consumers are known to purchase products (e.g., goods or services, etc.) from merchants. A product may be purchased through use of cash, a check, or a payment account, where the consumer provides payment in exchange for the product at the merchant, at a physical merchant location. Additionally, merchants are known to be associated with virtual merchant locations, such as websites, network-based applications, etc., where a consumer provides payment, and then the merchant arranges for delivery of the product to the consumer (or other designated person) through a courier. While the payment is generally made, by the consumer, at the time the purchase is initiated, it is also known for the merchant to accept “payment on delivery,” where the consumer pays for the product upon delivery of the product to the consumer. For example, food products are often ordered, where the merchant delivers the food products to the residence of the consumer, and then the consumer presents payment. Other “payment on delivery” options include delivery by a courier, where the consumer presents cash, check or payment account information to the courier for funding the transaction (whereby the courier then reimburses the merchant).

### DRAWINGS

The drawings described herein are for illustrative purposes only of selected embodiments and not all possible implementations, and are not intended to limit the scope of the present disclosure.

FIG. 1 illustrates an exemplary system of the present disclosure suitable for use in facilitating payment on delivery for products, at courier terminals, where the courier delivers products for multiple merchants;

FIG. 2 is a block diagram of a computing device that may be used in the exemplary system of FIG. 1; and

FIG. 3 is a flow diagram of an exemplary method, which may be implemented in connection with the system of FIG. 1, for facilitating payment on delivery for a product, at a courier terminal.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Consumers are known to order products from merchants, where the products are either paid for at the time of ordering, or at the time of delivery. When payment is received, as part of delivery, the payment is received at terminals which are specific to the merchant, or the courier delivering the product. As such, no efficient manner exists for payment on delivery situations, where payment is provided on delivery and/or where multiple different merchants provide the products for payment on delivery to a single courier.

Uniquely, the systems and methods herein permit courier terminals to be configured, by an order record (which may include, for example, an invoice number for billing ordered products, an order number for identifying the order, a merchant name, a merchant ID, a tracking number for use in reconciling with the order number, or a combination thereof, other data, etc.), to be specific to a merchant from which a product is ordered. In particular, when a product is designated for payment on delivery, an order record is delivered to a program manager. The program manager then provides the order record (including the various data/fields identified above) (which includes an address for a payment gateway, or is modified to include one) to a third-party courier (that is not part of the underlying transaction for the given product, but is responsible for delivering the product to a consumer). When a parcel (including the ordered product) is scanned for delivery, the order record is provided to the courier terminal, whereby the terminal is then configured (by the data included in the order record) as a point-of-sale (POS) terminal specifically for the merchant from which the product was ordered. In this manner, the third-party courier acts as an on-site stand in to receive payment for the product (even though the courier is not a direct party to the underlying transaction), but with the payment/funds directed to the merchant's account. What's more, for a parcel from a different merchant, the same courier terminal is configured (or reconfigured) otherwise, by the subsequent order record (and/or the other data/fields associated therewith) for the parcel, to be a POS terminal specifically for the different merchant, and any funds collected are sent directly to that merchant's account. Accordingly, order records are provided per parcel and/or per merchant, whereby the courier terminal is configurable (and reconfigurable), at the time of delivery, to act as a POS terminal specifically for different merchants. In addition, the payment (or funds) provided by a consumer for the parcel is routed generally directly to the appropriate merchant's account, via the courier terminal, and is not received by and/or accessible to the courier. This provides efficiency and improves conventional payment on delivery options.

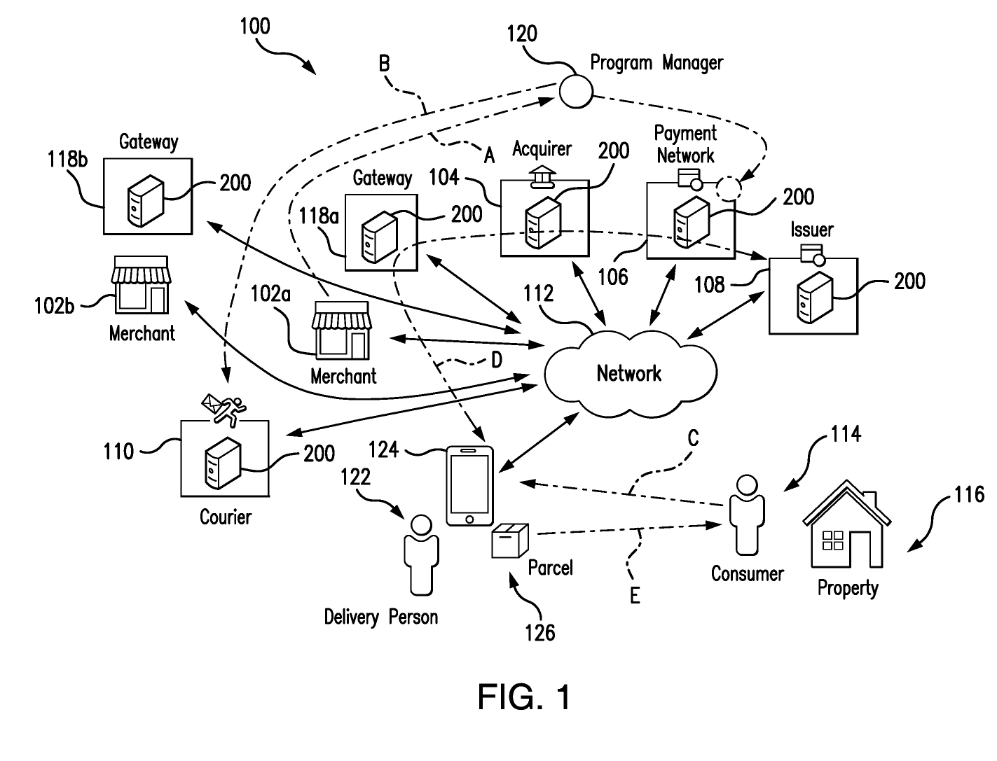

FIG. 1 illustrates an exemplary system 100 suitable for use in distributing parcels to recipients and facilitating payments for the products included in the parcels, and in which one or more aspects of the present disclosure may be implemented. Although the system 100 is presented in one arrangement, other embodiments may include the parts of the system 100 (or other parts) arranged otherwise depending on, for example, manners of payment for the products purchased from merchants, manners of shipping the products to consumers, etc.

The system 100 generally includes two merchants 102a-b, an acquirer 104 generally associated with the merchants 102a-b, a payment network 106, an issuer 108 configured to issue payment accounts (or other accounts) to consumers, and a courier 110, each of which is coupled to (and is in communication with) network 112 (where such communication is generally indicated by the double arrowed lines in FIG. 1). The network 112 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 112 may include multiple different networks, such as a private payment transaction network made accessible by the payment network 106 to the acquirer 104 and the issuer 108 and, separately, the public Internet, which may provide interconnection between the merchants 102a-b and/or the courier 110, etc.

In general herein, each of the merchants 102a-b offers products (e.g., goods, services, etc.) for sale to consumers, including to a consumer 114, etc. Specifically, in this example, the merchants 102a-b permit consumers to shop remotely (from the merchants 102a-b) and to order products for delivery to the consumers. For example, the merchants 102a-b may employ websites, network-based applications, catalogs, or others suitable mediums for providing details of products for sale and for ordering the products in such remote manner. In this way, consumers are not necessarily physically present at the merchant to take delivery of the products. In addition, the merchants 102a-b offer one or more payment options for funding the purchase of the product(s). Specifically, in this embodiment, the merchants 102a-b provide an option for payment on delivery of the products, whereby a product is routed to the consumer 114, for example, and payment is made, by the consumer 114, at the time of delivery. Additional detail about the “payment on delivery” option is described below.

Each of the merchants 102a-b is suited to participate in payment account transactions, whereby each of the merchants 102a-b is associated with a payment gateway. The merchant 102a is associated with payment gateway 118a, and the merchant 102b is associated with payment gateway 118b. Each of the payment gateways 118a-b may include, for example, a merchant virtual terminal, suitable for receiving payment account transaction requests from the corresponding one of the merchants 102a-b, specifically, from virtual merchant locations, or as described herein. As such, when credit card account information, for example, is presented directly to the merchant 102a to fund a purchase of a product (i.e., not a payment on delivery purchase), the merchant 102a compiles an authorization request for the transaction and routes the authorization request to the associated payment gateway 118a. The authorization request includes details of the transaction, including, for example, a transaction amount, time/date, terminal ID, currency code, merchant type, merchant category code (MCC), merchant account ID, merchant ID, merchant name, gateway ID, consumer name, and/or other suitable or conventional data, etc.

In such an exemplary transaction, the payment gateway 118a submits the authorization request for the transaction (including a payment account credential received from the consumer 114, for example) to the acquirer 104. The acquirer 104 communicates the authorization request to the issuer 108, via the payment network 106 (e.g., such as MasterCard®, VISA®, Discover®, American Express®, etc.), as is conventional. The issuer 108, then, determines whether the consumer's payment account is in good standing and whether there is/are sufficient funds and/or credit to cover the transaction, and potentially applies one or more fraud prevention rules, authentication rules, and/or validation rules thereto, etc. In response, an authorization reply (indicating the approval or decline of the transaction) is transmitted back from the issuer 108 to the merchant 102a, thereby permitting the merchant 102a to complete or abandon the transaction. Approved transactions are later cleared and/or settled by and between the merchant 102a, the acquirer 104, and the issuer 108 by appropriate agreements.

It should be appreciated that while described with reference to the merchant 102a and the payment gateway 118a, the description above is similarly applicable to the merchant 102b and the gateway 118b, as well as to other merchants and/or payment gateways, with the exception that content of the authorization request will generally be different (e.g., a different merchant ID, a different gateway ID, a different consumer payment account credential, etc.).

The consumer 114 is associated with a payment account issued by the issuer 108. The payment account permits the consumer 114 to fund transactions for products from the merchants 102a-b. In addition herein, the consumer 114 is associated with a property 116, which is associated with an address (e.g., a shipping address, etc.). The property 116 may include, for example, a home, an apartment, a condominium, an office building, or other suitable structure, location, etc. In general, the property 116 may include any location at which the consumer 114 may opt or decide to receive one or more products purchased from one or more of the merchants 102a-b, and will generally include a property at which the consumer 114 will be present to provide payment upon delivery.

With continued reference to FIG. 1, the courier 110 is generally a third-party entity that provides one or more services for delivery of packages from sources, such as, for example, the merchants 102a-b, to consumers at properties, such as the property 116. The courier 110 may include, for example, UPS®, DHL®, or FedEx®, or other suitable courier providing delivery services, etc. In the illustrated embodiment, the courier 110 will also agree with the merchants 102a-b, or a program manager 120 described below, to participate in payment on delivery options for products ordered from the merchants 102a-b. In connection therewith, the courier 110 is associated with delivery personnel, such as the delivery person 122, where each delivery person, including the delivery person 122, is associated with and/or provided with a mobile courier terminal 124. The courier terminal 124 includes computer-executable instructions, which, when executed, configure the terminal 124 to operate as described herein (e.g., to receive payment specific to the product being delivered, etc.). With that said, in general, the courier 110 is not normally a direct party to payment account transactions between the merchants 102a-b and the consumer 114.

While two merchants 102a-b, one acquirer 104, one payment network 106, one issuer 108, one courier 110, two payment gateways 118a-b, and one program manager 120 are illustrated in FIG. 1, it should be appreciated that any number of these entities (and their associated components) may be included in the system 100, or may be included as a part of systems in other embodiments, consistent with the present disclosure. Likewise, it should be appreciated that the system 100 is not limited to only one delivery person, one courier terminal and one consumer, as numerous couriers, portable communication devices and consumers will likely be included in various implementations of the systems and methods described herein. As such, the system 100 may accommodate multiple transactions similar to the ones described herein.

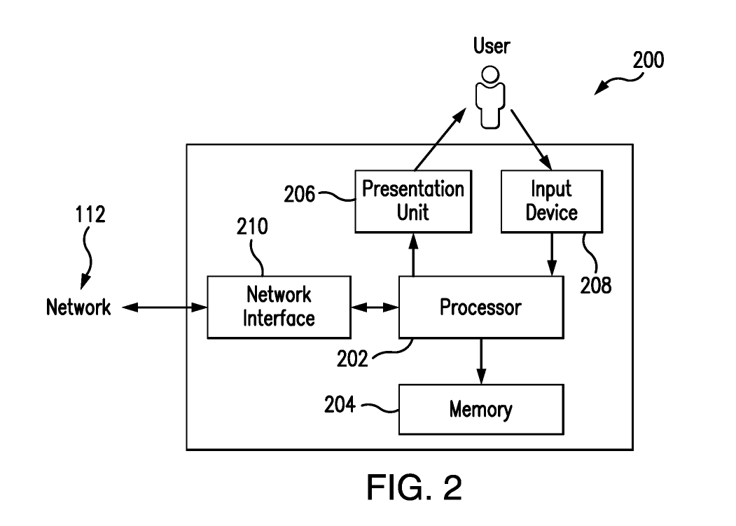

FIG. 2 illustrates an exemplary computing device 200 that can be used in the system 100. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to function as described herein. In the exemplary embodiment of FIG. 1, the acquirer 104, the payment network 106, the issuer 108, the courier 110, and the gateways 118a-b are each illustrated as including, or being implemented in, computing device 200, coupled to (and in communication with) the network 112. In addition, the merchants 102a-b may also be considered as including and/or being implemented in at least one computing device consistent with computing device 200. Further, the courier terminal 124 associated with delivery person 122 can be considered a computing device consistent with computing device 200 for purposes of the description herein. However, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, order records (and the various data associated therewith), transaction data, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 and/or other computer system components configured to perform one or more of the various operations herein. It should be appreciated that the memory 204 may include a variety of different memories, each implemented in one or more of the functions or processes described herein.

In the exemplary embodiment, the computing device 200 also includes a presentation unit 206 that is coupled to (and is in communication with) the processor 202 (however, it should be appreciated that the computing device 200 could include output devices other than the presentation unit 206, etc. in other embodiments). The presentation unit 206 outputs information (e.g., payment authorized messages, etc.), visually, for example, to a user of the computing device 200, such as the delivery person 122 in the system 100, etc. And, various interfaces (e.g., as defined by network-based applications, etc.) may be displayed at computing device 200, and in particular at presentation unit 206, to display certain information. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

In addition, the computing device 200 includes an input device 208 that receives inputs from the user (i.e., user inputs) such as, for example, inputs by the delivery person 122 of payment account credentials (e.g., a primary account number or PAN, expiration data (e.g., an expiration date for a payment device, etc.), etc.) or entries of order record identifiers, etc. to the courier terminal 124, as described herein, etc. The input device 208 may include a single input device or multiple input devices. The input device 208 is coupled to (and is in communication with) the processor 202 and may include, for example, one or more of a keyboard, a pointing device, a mouse, a touch sensitive panel (e.g., a touch pad or a touch screen, etc.), a magstripe reader (e.g., for receiving payment credentials from a consumer payment device, etc.), a chip reader (e.g., for receiving payment credentials from a consumer payment device, etc.), a near field communication reader (e.g., for receiving payment credentials from a consumer payment device, etc.), another computing device, and/or an audio input device, etc. Further, in various exemplary embodiments, a touch screen, such as that included in a tablet, a smartphone, or similar device, may behave as both the presentation unit 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC™) adapter, a Bluetooth™ adapter, etc.), a mobile network adapter, or other device capable of communicating to one or more different networks, including the network 112. In some exemplary embodiments, the computing device 200 may include the processor 202 and one or more network interfaces incorporated into or with the processor 202.

Referring again to FIG. 1, the system 100 includes the program manager 120, which is specifically configured, by computer executable instructions, to perform one or more of the operations described herein. In the illustrated embodiment, the program manager 120 is provided as a separate part of the system 100 and is in communication with other parts of the system 100, through the network 112. As such, the program manager 120 may be considered (or may be implemented in) a computing device consistent with computing device 200. That said, the program manager 120 may be incorporated, or integrated, in whole or in part, with the payment network 106, for example, as indicated by the dotted line and dotted circle in FIG. 1. It should be appreciated, though, that the program manager 120 may be associated with, or incorporated with, still other parts of the system 100, in other embodiments, etc.

In the exemplary embodiment, when the consumer 114 orders a product at the merchant 102a, for example, and opts for payment on delivery, the merchant 102a is configured to compile an order record for the product for transmission to the program manager 120. The order record, in this example, includes at least a courier ID for the courier 110, as the delivery service provider for the product, and a gateway ID for the payment gateway 118a. The order record may also include, without limitation, a parcel ID, a tracking number, an order ID (e.g., an order number, etc.), an invoice ID (e.g., an invoice number, etc.), a product ID and/or name, a product/parcel tracking number, a merchant ID, a merchant name, a product price, a total price, shipping costs, a shipping or property address (e.g., a consumer address for the property 116, etc.), a consumer ID and/or name for the consumer 114, a merchant account number, an acquirer ID for the acquirer 104 associated with the merchant 102a, etc. The merchant 102a then provides the order record, along path A in FIG. 1, to the program manager 120. In addition, the merchant 102a causes a parcel 126 (including the purchased product) to be initially provided to the courier 110. The parcel 126 is appended with a parcel ID, an order number, a tracking number, and/or a merchant ID or other indicium, all of which may also be included in the order record and later used by the courier 110 to link the order record to the parcel 126.

In response, the program manager 120 is configured to identify the courier 110, from (or based on) the order record, and to transmit the order record to the courier 110, along path B in FIG. 1. Upon receipt of the order record, the courier 110 is configured to identify the product/parcel 126 (also based on the order record), and provide the parcel 126 to the delivery person 122. Thereafter, the delivery person 122 sets out to deliver the parcel 126 to the consumer 114. In connection with arrival at the property 116, the courier terminal 124 is configured to scan or otherwise receive (e.g., by manual entry from the delivery person 122, by scanning an indicia on the parcel 126 using the courier terminal 124, etc.) one or more of the parcel ID, the tracking number, the order number, the merchant ID, a consumer ID, etc., from the parcel 126 (and/or the delivery person 122), and to retrieve the order record (including configuration data associated with the order record), or part thereof, from the courier 110 based on the scanned or received information from the parcel 126. It should be appreciated, however, that in alternate embodiments, the courier terminal 124 may be configured to request configuration data for the merchant 102a and/or the parcel 126 from the program manager 120, without going through the courier 110. In such embodiments, the program manager 120 may be configured to retrieve the order record from its memory and return the order record, in whole or in part, to the courier terminal 124 (e.g., without interacting with the courier 110, etc.).

In any case, after receipt of the order record from the courier 110, the courier terminal 124 then configures itself according to the order record, and specifically, according to the payment gateway 118a and/or merchant 102a identified in the order record (and to the particular product(s) including in the parcel 126, so that payment can be facilitated for the particular product(s)). For example, the courier terminal 124 may configure itself to use the payment gateway address, associated with the gateway ID and/or merchant ID provided in the order record, for the payment gateway 118a to specifically initiate a payment account transaction for the parcel 126 to the consumer 114. Broadly, the courier terminal 124 is configured to impose the configuration parameters included in the order record upon itself (e.g., in order to specifically operate on behalf of the merchant 102a to facilitate the payment account transaction for the specific product(s) received in the parcel 126 to the payment account associated with the consumer 114, etc.) (whereby the courier terminal 124 operates as a POS terminal for the merchant 102a). Subsequently, or prior to, or during, the delivery person 122 requests that the consumer 114 provide payment for the product (included in the parcel 126). The consumer 114, in turn, provides at least one credential associated with the payment account issued by the issuer 108 to the delivery person 122 and/or the courier terminal 124.

For example, the delivery person 122 may swipe or otherwise present the at least one payment account credential for the consumer to the courier terminal 124, whereby the courier terminal 124 is configured to then receive the at least one credential for the payment account (e.g., receive via a card swipe or contactless reader, or receive via manual entry, etc.), along path C in FIG. 1. The courier terminal 124 is configured to then compile and transmit an authorization request (to fund payment for the product upon delivery of the parcel 126 to the consumer 114), along path D in FIG. 1, to the payment gateway 118a, as specified by the order record. In connection therewith, information for the acquirer 104 (e.g., an acquirer ID, etc.) may also be included in the authorization request by the courier terminal 124 (whereby the payment gateway 118a may then identify the acquirer 104). For example, the courier terminal 124 may retrieve such acquirer information from the order record, or such information may be included directly at the courier terminal 124 and retrieved based on a merchant ID included in the order record (e.g., the courier terminal 124 may be pre-programmed with acquirer information for certain merchants, etc.). Alternatively, when such acquirer information is not included in the authorization request received from the courier terminal 124, the payment gateway 118a may identify the acquirer 104 itself upon receipt of the authorization request (e.g., based on a merchant ID included in the authorization request or other merchant identifier, etc.). In any case, the courier terminal 124, as specifically configured for the merchant 102a, operates in a manner not normal for the courier terminal 124, in that the courier terminal 124 is configured (or reconfigured, as appropriate) to generate the authorization request for the given transaction between the merchant 102a and the consumer 114.

Similar to the above, then, the payment gateway 118a submits the authorization request for the transaction to the acquirer 104. And, the acquirer 104 communicates the authorization request to the issuer 108, via the payment network 106 (e.g., such as MasterCard®, VISA®, Discover®, American Express®, etc.). The issuer 108, then, determines whether the consumer's payment account is in good standing and whether there is/are sufficient funds and/or credit to cover the transaction, and potentially applies one or more fraud prevention rules, authentication rules, and/or validation rules thereto, etc. In response, an authorization reply (indicating the approval or decline of the transaction) is transmitted back from the issuer 108 to the courier terminal 124, along path D, thereby permitting the courier 110, on behalf of the merchant 102a, to complete or abandon the transaction. Approved transactions are later cleared and/or settled by and between the merchant 102a, the acquirer 104, and the issuer 108 by appropriate agreements.

When the authorization reply is received at the courier terminal 124, with an indication of approval, the delivery person 122 is then able to complete delivery (and/or allow for release) of the parcel 126 to the consumer 114, along path E in FIG. 1.

In some embodiments, the courier terminal 124 may be preconfigured with a listing of all available payment gateways, whereby the courier terminal 124 may then select the appropriate payment gateway based on data included in the received order record (e.g., based on a merchant ID or other merchant identifier included in the retrieved/received order record, etc.). In such embodiments, the order record compiled at the merchant 102a may not include the gateway ID for the payment gateway 118a, and the program manager 120 then may not need to modify the order record to include the payment gateway address.

While the above is described with reference to the merchant 102a, the courier terminal 124 should be understood to be configured similarly for a product provided from the merchant 102b (or another or other merchant(s)), in that the courier terminal 124 is configured, according to a different order record, to compile and transmit the authorization request to the payment gateway 118b (on behalf of the merchant 102b, for example). In this manner, the courier terminal 124 is configured according to the specific merchant and/or the specific payment gateway for the merchant from which the given product is purchased (and the corresponding specific acquirer associated with the merchant, the specific issuer associated with the payment credentials received from the consumer, the specific payment network configured to handle such transaction, etc.), whereby the courier terminal 124 acts as a dynamic, on-site mobile POS terminal for the specific merchant corresponding to the parcel being delivered at that time. As such, the merchants 102a-b are paid directly upon delivery, while the courier 110 is permitted to use a single courier terminal 124 for multiple, different merchant and/or payment gateways, and while not actually having to handle or accept funds from the consumer 114 to effect payment on delivery of the parcel 126 and associated purchased product(s). The payment (or funds) provided by the consumer 114 for the parcel 126 (and product(s)) is routed generally directly to the appropriate merchant's account, via the courier terminal 124, and is not received by and/or accessible to the courier 110 (e.g., the funds do not flow through, are not deposited in, etc. an account of the courier 110, etc.).

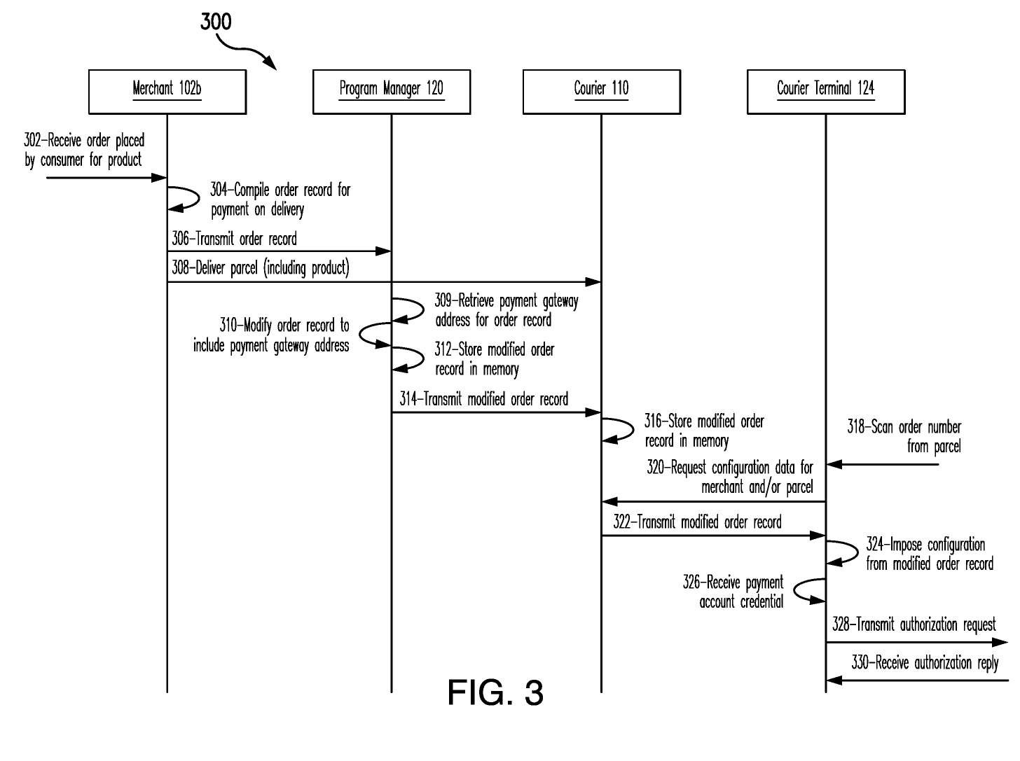

FIG. 3 illustrates an exemplary method 300 for use in delivery of a product to a consumer, whereby payment for the product is received upon delivery. The exemplary method 300 is described as implemented generally in the merchant 102b, the payment gateway 118b, the program manager 120 and the courier terminal 124 and, generally, the system 100. The method 300 is also described with reference to the computing device 200. That said, however, the methods herein should not be understood to be limited to the system 100 or the computing device 200, as the methods may be implemented in other systems and/or computing devices. Likewise, the systems and the computing devices herein should not be understood to be limited to the exemplary method 300.

At the outset, in this exemplary embodiment, the merchant 102b is registered with the program manager 120, and as such, the program manager 120 includes a data structure (broadly, a mapping data structure), which maps the merchant 102b, and specifically, the merchant ID and/or gateway ID of the merchant 102b, to the associated payment gateway, i.e., the payment gateway 118b (including the address thereof).

At 302, the merchant 102b receives an order for a product from the consumer 114. The order, for the product, is accompanied by a request and/or direction for payment on delivery of the product to the consumer 114 at the property 116. As such, the merchant 102b compiles, at 304, an order record for the product, which may include, for example, one or more of the data parameters included in Table 1, below. The merchant 102b then transmits the order record to the program manager 120, at 306, and further delivers the parcel, including the product ordered, to the courier 110, at 308, for delivery to the consumer 114.

TABLE 1

Merchant ID for merchant 102b
Merchant Name for merchant 102b
Merchant Address for merchant 102b
Product ID(s) and Product Name(s) for purchased product(s)
Order Number
Tracking Number
Courier ID for courier 110
Consumer ID and Consumer Name for consumer 114
Gateway ID for gateway 118b
Consumer Address for consumer 114
Product Price(s) for purchased product(s)
Taxes
Shipping Costs
Total Price
Terminal ID for courier terminal 124

It should be appreciated that other embodiments, the order record may include only a subset of the data parameters included in Table 1, or it may additional data or different data, so long as the data is sufficient to identify a gateway address for the merchant 102b and allow the courier terminal 124 to configure itself to issue an authorization request to the payment gateway 118b for the merchant 102b.

With continued reference to FIG. 3, in response to the order record, the program manager 120 retrieves, at 309, a payment gateway address for the payment gateway 118b, for example, based on the merchant ID and/or gateway ID included in the order record. The program manager 120 then, optionally, modifies the order record to include the payment gateway address, at 310. Specifically, the program manager 120 accesses the mapping data structure and then searches for the merchant ID and/or gateway ID included in the order record for the merchant 102b. When the merchant ID and/or gateway ID is found, the program manager 120 identifies the associated payment gateway 118b as the gateway for the merchant 102b (and the address thereof), and then modifies the order record to include the address for the payment gateway 118b. The program manager 120 then stores, at 312, the modified order record in memory (e.g., the memory 204, etc.). It should be appreciated that when the order record already includes an address or other suitable identifier for the payment gateway 118b, the program manager 120 may store the order record without modifying the order record.

The program manager 120 then identifies the courier 110 to which the parcel was provided (e.g., via the order record, etc.) and transmits, at 314, the modified order record to the courier 110 (or, alternatively, the original order record if it already includes the gateway address). In this exemplary embodiment, the courier 110 may be identified, by the program manager 120, from the order record received from the merchant 102b (e.g., based on the courier ID, etc.). The courier 110 may be identified otherwise in other embodiments, such as, for example, based on the merchant ID, where the merchant 102b, for example, uses the same courier 110 for all payment on delivery transactions, etc. The modified order record is received by the courier 110, and then, at 316, is stored, by the courier 110, in memory (e.g., the memory 204, etc.) (e.g., in association with the parcel 126 as identified base on a correlation between an order number for the parcel 126 and a tracking number for the parcel 126, etc.).

Subsequently, upon delivery of the parcel 126 to the consumer 114 at the property 116, the delivery person 122 scans the order number, at 318, for example, via a barcode or QR code on the parcel 126, using the courier terminal 124. The courier terminal 124, in turn, requests, at 320, configuration data for the parcel 126, as identified based on the scanned order number. In response, the courier 110 retrieves the modified order record from memory (e.g., the memory 204, etc.), based on the order number/tracking number, and returns the modified order record, in whole or in part, to the courier terminal 124, at 322. It should be appreciated, however, that in alternate embodiments, the courier terminal 124 may request configuration data for the merchant 102b and/or the parcel 126 from the program manager 120, without going through the courier 110. In such embodiments, the program manager 120 may retrieve the modified order record from its memory and return the modified order record, in whole or in part, to the courier terminal 124 (e.g., without interacting with the courier 110, etc.). In addition, in some embodiments, the courier terminal 124 may request the configuration data for the merchant 102b and/or the parcel 126 based on other information (e.g., scanned or manually entered from the parcel 126, etc.), such as, for example, a merchant ID, a consumer ID, etc. The courier 110 and/or program manager 120, then, may retrieve the modified order record based on the other information.

With further reference to FIG. 3, the courier terminal 124, then, in response to the modified order record, or part thereof, configures itself, at 324, according to the modified order record (e.g., to identify the payment gateway address for the transaction to be initiated at the courier terminal 124 for the product in the parcel 126, etc.). Specifically, the courier terminal 124 configures itself to use the values associated with one or more of the parameters included in Table 1 above, as provided from the program manager 120 in the order record (in response to the scan of the parcel 126, for example), to generate and issue a transaction authorization request to the payment gateway 118b.

Thereafter, the delivery person 122 requests a payment account credential (e.g., via the courier terminal 124, etc.) for the payment account to fund the transaction, whereupon the consumer 114 presents a payment account device (e.g., a credit card, etc.), and from which the courier terminal 124 receives, at 326, the payment account credential. The courier terminal 124 then compiles and transmits the authorization request, for the transaction, to the payment gateway 118b, at 328. The authorization request includes the received payment account credential and, as necessary, information from the order record listed in Table 1 above, such as, for example, a product price for each individual one of the products in the parcel 126, a total transaction amount based on the price(s) of the product(s) in the parcel 126, a product ID and/or product name for each of the products in the parcel 126, an order number, a consumer ID and/or consumer name for the consumer 114, a gateway ID for the gateway 118b, etc. From the payment gateway 118b, the authorization request is passed to the acquirer 104 and on to the issuer 108, as described above. Upon approval or decline, by the issuer 108, an authorization reply is transmitted back from the issuer 108 to the courier terminal 124. The courier terminal 124 receives the authorization reply, at 330. When the authorization reply indicates approval, the delivery person 122 then delivers the parcel to the consumer 114 and proceeds to a next parcel delivery.

The method 300 is repeated for each parcel for which payment is to be received on delivery. As such, when different configurations are imposed on the courier terminal 124, by other order records for other merchants (as retrieved in response to a scans of other parcels by the courier terminal 124, or other inputs to the courier terminal 124 in order to identify the parcels), the courier terminal 124 is reconfigured for each of the different merchants (based on the received different order records) and effectively converted from a mobile POS terminal for one merchant (e.g., the merchant 102a, etc.) to a mobile POS terminal for another merchant (e.g., the merchant 102b, etc.), and so on. In this manner, the courier terminal 124 (which is not conventionally a POS terminal), functions as a POS terminal for a specific merchant (i.e., is specifically configured) and routes the payment account transaction to the payment gateway associated with the merchant involved in the given order record, based on identification of the order at the time of delivery. This provides an efficient technique for the courier 110 to stand in as the POS terminal for multiple different merchants through the same third-party device (whereby the same courier terminal 124 can be switched for use by multiple different merchants for their specific products being sold/delivered to consumers by the third party courier 110). As such, through use of the courier terminal 124 associated with the courier 110 (generally, a third party to a given transaction between a consumer and a merchant), the path of the given payment account transaction is altered (even though the transaction originates from the third-party courier terminal 124), whereby the third-party courier 110 then provides (in an unconventional manner) an authorization request for the given transaction. In this manner, the courier 110 ultimately provides payment on delivery options for multiple different merchants.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations recited in the claims herein.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for facilitating, at a mobile courier terminal, payment on delivery for products delivered to consumers by a courier associated with the courier terminal, where the products are provided by multiple different merchants, the method comprising:
receiving, by a computing device, an order record from a merchant, the order record identifying a product ordered by a consumer and including a merchant ID for the merchant;
retrieving, by the computing device, from a mapping data structure, a payment gateway address associated with the merchant ID, the payment gateway address for a payment gateway associated with the merchant;
modifying, by the computing device, the order record to include the payment gateway address; and
transmitting the modified order record to a courier, thereby permitting the payment gateway address to be imposed on a mobile courier terminal associated with the courier such that a payment account transaction initiated at the mobile courier terminal for payment on delivery of the product is directed to an account specific to the merchant, via the payment getaway.

2. The computer-implement method of claim 1, wherein the modified order record includes at least the payment gateway address, the merchant ID, a terminal ID for the mobile courier terminal, a merchant name of the merchant, and a merchant address of the merchant.

3. The computer-implement method of claim 1, wherein the merchant is a virtual merchant and the payment gateway includes a merchant virtual terminal.

4. The computer-implemented method of claim 1, further comprising:
receiving, by the computing device, a second order record from a second merchant, the second order record identifying a second product ordered by a consumer and including a second merchant ID for the second merchant;
retrieving, by the computing device, from the data structure, a second payment gateway address associated with the second merchant ID for the second merchant, the second payment gateway address associated with a second payment gateway associated with the second merchant, the second payment gateway address different than said payment gateway address;
modifying, by the computing device, the second order record to include the second payment gateway address; and
transmitting the modified second order record to the courier, thereby permitting the second payment gateway address to be imposed on the mobile courier terminal such that a payment account transaction initiated for payment on delivery of the second product at the mobile courier terminal is directed to the account specific to the second merchant, via the second payment getaway.

5. A system for facilitating payment for a product through a courier terminal upon delivery of the product to a consumer, the system comprising:
a program manager computing device in network communication with a merchant, the program manager computing device configured to:
receive an order record from the merchant identifying a product ordered by a consumer from the merchant, the order record including a merchant ID for the merchant;
identify, in a mapping data structure, based on the merchant ID, a payment gateway address for a payment gateway associated with the merchant; and
modify the order record to include the payment gateway address; and
a courier terminal comprising computer-executable instructions, which, when executed by the courier terminal, cause the courier terminal to:
scan an indicia associated with the product in connection with delivery of the product to the consumer;
request, based on the scanned indicia, the modified order record for the product; and
after receiving the modified order record, transmit an authorization request for a payment account transaction involving the product to the payment gateway address included in the modified order record, such that the payment account transaction is initiated for the product at the courier terminal on delivery of the product to the consumer.

6. The system of claim 5, wherein the computer-executable instructions, when executed by the courier terminal, cause the courier terminal, in connection with scanning the indicia associated with the product, to scan the indicia associated with the product when the product is at a property associated with the consumer.

7. The system of claim 5, wherein the computer-executable instructions, when executed by the courier terminal, cause the courier terminal, in connection with requesting the modified order record for the product, to transmit, to a courier computing device in network communication with the program manger computing device, at least one of an order number for the product, a consumer ID of the consumer, and the merchant ID of the merchant, thereby permitting the courier computing device to link the modified order record to the product; and
wherein the computer-executable instructions, when executed by the courier terminal, further cause the courier terminal to receive the modified order record from the courier computing device.

8. The system of claim 7, wherein the computer-executable instructions, when executed by the courier terminal, cause the courier terminal, in connection with scanning the indicia associated with the product, to retrieve the at least one of the order number for the product, the consumer ID of the consumer, and the merchant ID of the merchant from the indicia.

9. The system of claim 5, wherein the computer-executable instructions, when executed by the courier terminal, further cause the courier terminal to request a payment account credential from the consumer and receive, at the courier terminal, the payment account credential.

10. The system of claim 9, wherein the computer-executable instructions, when executed by the courier terminal, further cause the courier terminal to append the payment account credential to the authorization request.

11. The system of claim 5, wherein the computer-executable instructions, when executed by the courier terminal, further cause the courier terminal to receive an authorization reply for the payment account transaction, in response to the authorization request.

12. A computer-implemented method for facilitating, at a courier terminal, payment on delivery of products to consumers, where the products are offered for sale to the consumers by multiple different merchants, the method comprising:
receiving, by a courier terminal, a payment gateway address for a payment gateway of a merchant and a price for a product purchased by a consumer from the merchant in connection with delivery of the product to the consumer;
receiving, by the courier terminal, payment account information associated with the consumer;
configuring, by the courier terminal, the courier terminal to transmit an authorization request for a payment account transaction involving the product to the payment gateway address;
transmitting, by the courier terminal, the authorization request to the payment gateway address, the authorization request including a transaction amount based on the price for the product and the payment account information associated with the consumer; and
receiving, by the courier terminal, an authorization reply indicating approval of the authorization request.

13. The computer-implemented method of claim 12, further comprising transmitting, by the courier terminal, to a courier computing device, a request for the payment gateway address for the payment gateway of the merchant, the request including at least one of an order number for the product, a consumer ID of the consumer, and a merchant ID of the merchant.

14. The computer-implemented method of claim 13, further comprising scanning, by the courier terminal, an indicia associated with the product and obtaining, from the scanned indicia, the at least one of the order number for the product, the consumer ID of the consumer, and the merchant ID of the merchant; and
generating the request for the payment gateway address and including, in the request, the at least one of the order number, the consumer ID of the consumer, and the merchant ID of the merchant obtained from the indicia.

15. The computer-implemented method of claim 12, wherein receiving the payment gateway address for the payment gateway of the merchant includes receiving an order record comprising the payment gateway address; and
wherein configuring the courier terminal to transmit the authorization request for the payment account transaction to the payment gateway includes imposing, by the courier terminal, a configuration from the order record on the courier terminal such that the payment account transaction initiated for the product is directed to the payment gateway of the merchant and an account specific to the merchant.

16. The computer-implemented method of claim 12, further comprising releasing the product to the consumer upon receipt of the authorization reply.

17. The computer-implemented method of claim 12, further comprising requesting, by the courier terminal, a payment account credential from the consumer and receiving, at the courier terminal, the payment account credential.
